(19) United States
(12) Patent Application Publication
(10) Pub. No.: US 2016/0236018 A1
(43) Pub. Date: Aug. 18, 2016

(54) Easy to Assemble Anti-dropping Device

(71) Applicant: Aerohook Technology Co., Ltd., Taichung City (TW)

(72) Inventors: Yang Tsung Chen, Taichung City (TW); Chia Cheng Huang, Taichung City (TW)

(21) Appl. No.: 14/622,901

(22) Filed: Feb. 15, 2015

(51) Int. Cl. A62B 35/00; E04G 21/32

(52) U.S. Cl. CPC A62B 35/0093; E04G 21/3204

(57) ABSTRACT

An easy to assemble anti-dropping device includes a supporting rack which has a chamber and is installed a central axle crossing the chamber which is for placing a circle of a rotary drum circled by a rescue cord, a rotor installed a bias rotary member, and a turbination spring, and has the central axle pass through the rotary drum and the central opening of the rotor, is characterized in that the supporting rack is formed from a upright board having a first hole, a lateral board extended from top side of the upright board, and a breaking frame detachably installed on the free end of the lateral board, wherein the breaking frame has a foramen for the bias rotary member to buckle in by instantaneous rotary acceleration and a covering board opposite the upright board and sealed off on the outer side of the foramen, wherein the covering board has a second hole which matches with the first hole, so as to allow the first hole of the upright board or the second hole of the breaking frame to separately let the central axle to passingly catch to allow the central axle to pass through the central opening of the rotor and the central hole of the rotary drum in a manner of maximum moving allowance, and to eventually set up the breaking frame on the lateral board, which structural setting can certainly greatly improve the assembling efficiency of an anti-dropping device.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention is an easy to assemble anti-dropping device, herein in particularly meaning a technique to improve the efficiency of assembling a central axle through a redesign of a supporting rack, which can certainly eliminate various troubles and disadvantages in assembling the central axle of the conventional central axle.

2. Description of Related Arts

According to the latest anti-dropping device, such as described in the published patent case, US2013/0105247, the assembling process in the published patent case requires aligning a rotary drum 150, a rotor 162, and a turbination spring 159 to put into a reverse U shaped chamber of a supporting rack 124, and using a central axle 184 to insert into an orifice 105 of the supporting rack 124 and to pass through the rotary drum 150 and a central hole of the rotor 162, so as to insert into another orifice 115 of the supporting rack 124.

However, in the published patent case it is hard and time consuming to install the central axle 184 because the central axle 184 has to be restricted by the orifice 105 of the supporting rack 124, and the rotary drum 150, the rotor 162, and the turbination spring 159 have to be restricted in the reverse U shaped chamber, so it is impossible to see the central hole of the rotary drum 150 and the rotor 162 and, therefore, there is a need to frequently align through moving the central axle 184 back and forth to adjust the positions of the rotary drum 150 and the rotor 162, which not only increases the working time for more times of the action to hinder the efficiency of the assembling, but also hinders the growth of the economic effectiveness, which is the bottleneck of current technology.

### SUMMARY OF THE PRESENT INVENTION

The present invention provides an easy to assemble anti-dropping device, which is characterized in that the supporting rack is formed from a upright board having a first hole, a lateral board extended from top side of the upright board, and a breaking frame detachably installed on the free end of the lateral board to define a chamber, wherein the breaking frame has a foramen concentric with the first hole, a covering board sealing off the outer side of the foramen, wherein the covering board has a second hole which matches with the first hole, so as to allow the first hole and the second hole to be passed through by a central axle.

Therefore, the first hole of the upright board or the second hole of the breaking frame of the present invention can first separate to allow the central axle to pass, so as to let the central axle to pass through the central opening of the rotor and the central hole of the rotary drum in a manner of maximum moving allowance, and to eventually set up the breaking frame on the lateral board, which structural setting can certainly greatly reduce the assembly costs and improve on the disadvantages of assembling a current anti-dropping device.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded view of the present invention.

FIGS. 2 and 3 are external views of partial assemblages of FIG. 1.

FIG. 4 is a 3D schematic diagram of an assemblage of the present invention.

FIG. 5 is a schematic diagram of left side of an assemblage of the present invention.

FIG. 6 is a schematic diagram of the present invention showing whether the bias rotary member has buckled into the foramen.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

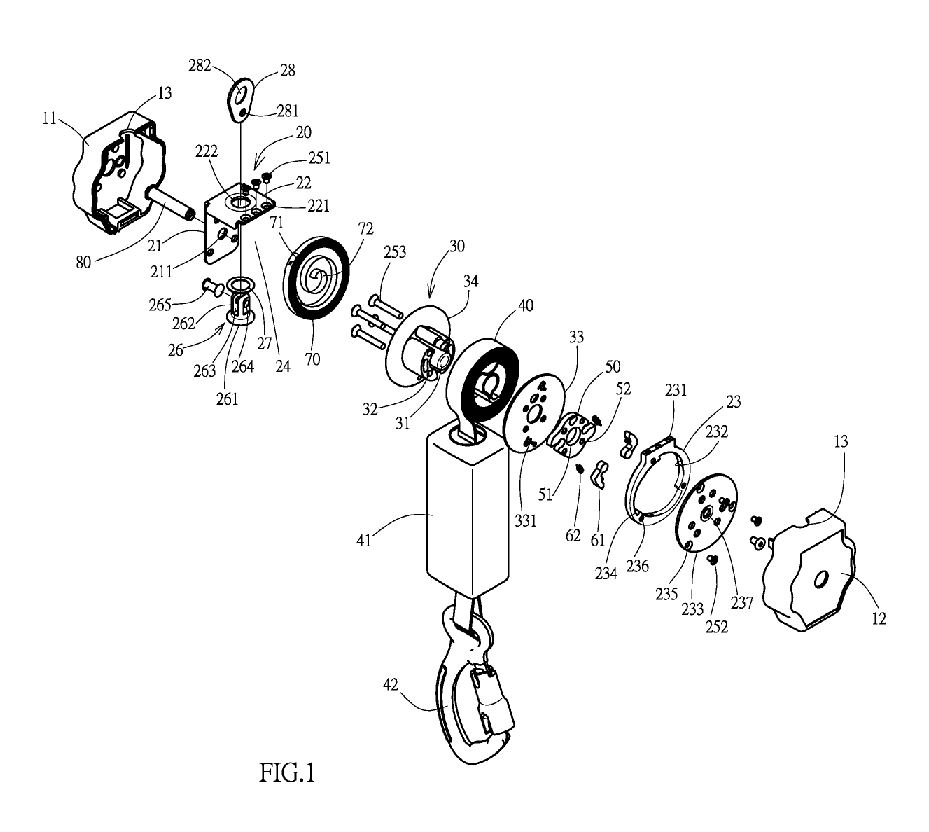

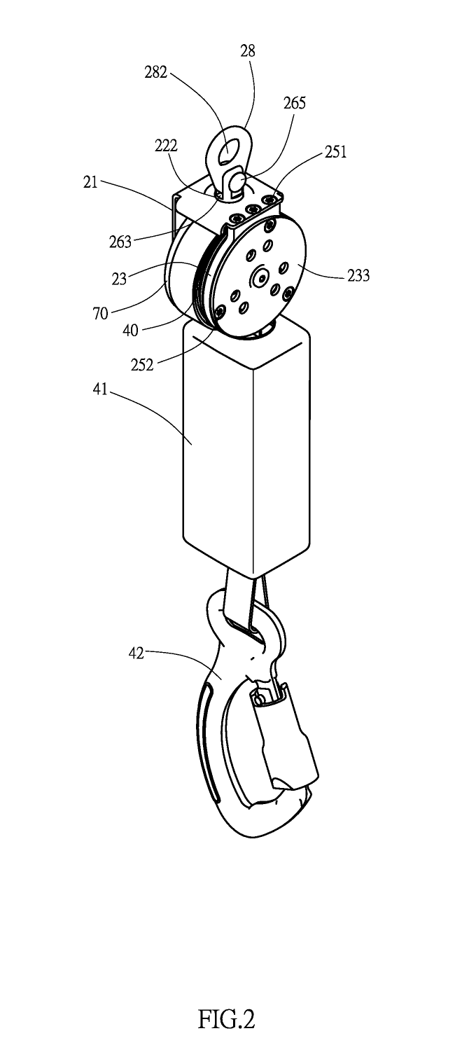

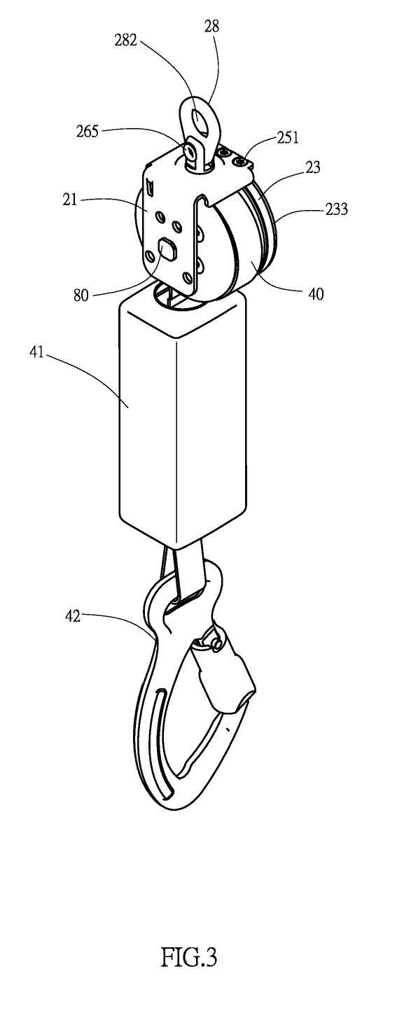

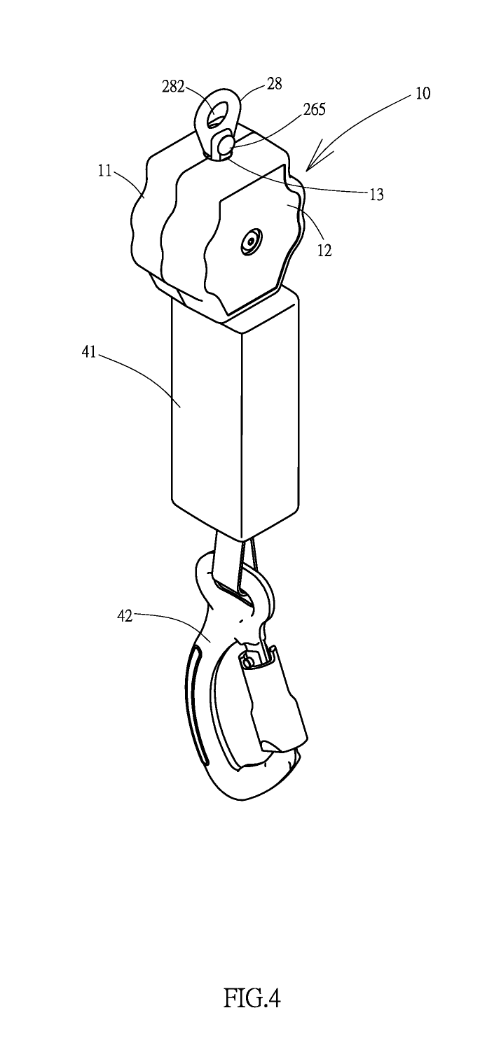

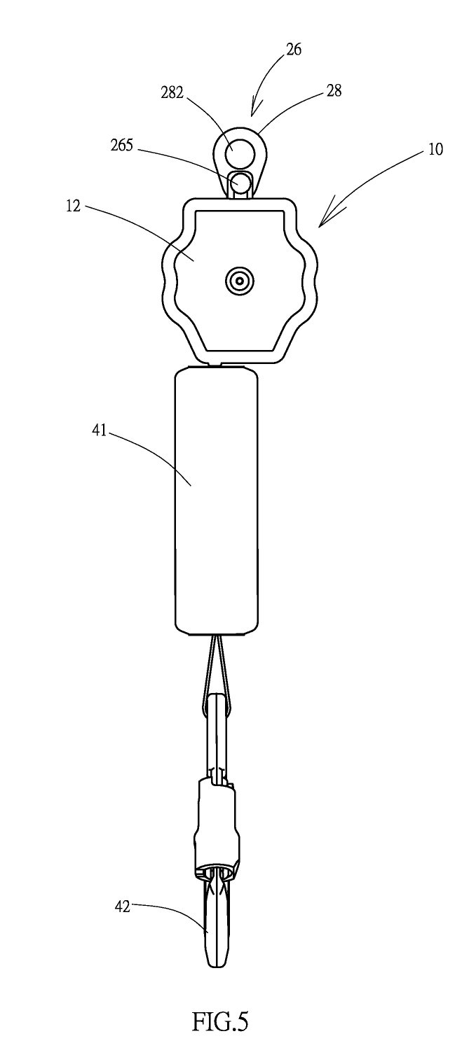

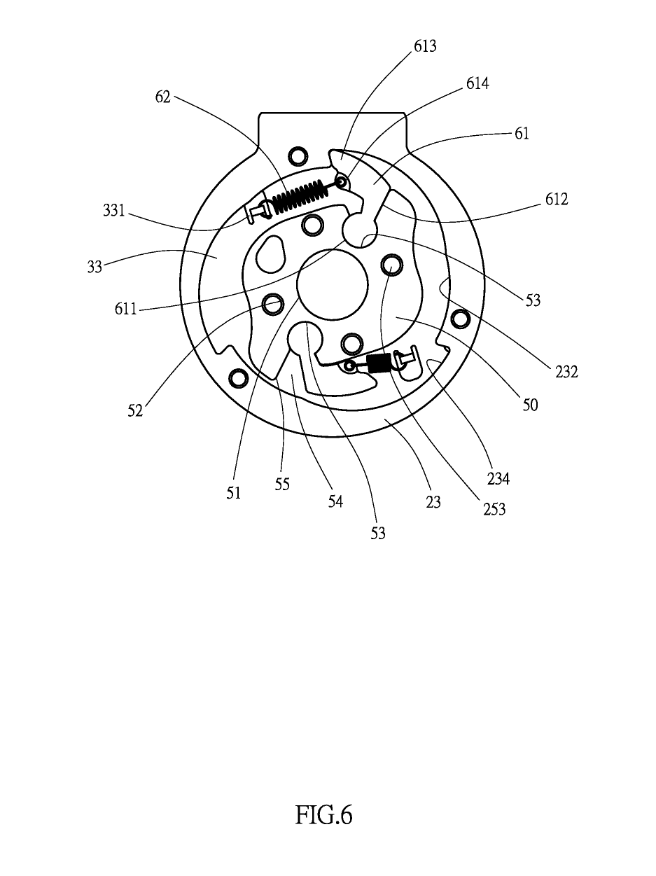

Referring to FIGS. 1-6, the present invention comprises:

an internally hollow shell body 10 formed by coupling a first shell 11 and a second shell 12, wherein the top of the shell body 10 has an upper hole 13 connecting inside out and the bottom of the shell body 10 has a lower hole (not shown on the figures) connecting inside out;

a supporting rack 20 installed inside of the shell body 10, wherein the supporting rack 20 is formed from an upright board 21 having a first hole 211, a lateral board 22 extended from top side of the upright board 21, and a breaking frame 23 detachably installed on the free end of the lateral board 22, so as to have the upright board 21, the lateral board 22, and the breaking frame 23 define a chamber 24, wherein a first binding hole 221 and a first screw hole 231 are correspondingly set where the lateral board 22 and the breaking frame 23 attach to one another, so as to detachably install the breaking frame 23 on the free end of the lateral board 22, wherein the breaking frame 23 further has a laterally penetrated foramen 232 concentric with the first hole 211 and a covering board 233 sealing off the outer side of the foramen 232, wherein the foramen 232 at least has a radially hollowed positioning unit 234, wherein a second binding hole 235 and a second screw hole 236 are correspondingly set where the covering board 233 and the breaking frame 23 attach to one another, so as to allow the second screw 252 to affix the covering board 233 with the breaking frame 23 to detachably seal the covering board 233 on the foramen, wherein the covering board 233 also has a second hole 237 passing through which matches with the first hole 211, wherein the center of the lateral board 22 further has a coupling hole 222 passing through for installation of a hanging set which is formed from a turning holder 26, a washer 27, and a lifting lug 28, wherein the turning holder 26 has a base portion 261 stopped on the bottom of the lateral board 22 and has an axle portion 262 which is extended up from the bottom and passes through the washer 27, the coupling hole 222, and the upper hole 13, wherein the axle portion 262 also concavedly has a radially penetrated cutting slot 263 which is to be inserted by the base portion of the lifting lug 28, wherein the axle portion 262 and the lifting lug 28 have a corresponding first pivot hole 264 and a corresponding second pivot hole 281 to let an axle element 265 to couple the first pivot hole 264 with the second pivot hole 281, wherein the top portion of the lifting lug 28 has a fixing hole 282 to provide hangingly securing, so the supporting rack 20 of the present invention can use the axle portion 262 and the axle element 265 as pivot to perform positioning adjustment with universal angle, which can flexibly respond to the user's movement;

a rotary drum 30 accommodated in the chamber 24, wherein the rotary drum 30 comprises a central hole 31 which passes through both the left and right sides of the rotary drum 30, and four eccentric holes 32 which are for a third screw 253 to passingly catch to lockingly affix a first side board 33 which radially protrudes on a side of the rotary drum 30, wherein the first side board 33 further symmetrically has at least one first spring base 331 inserting in the foramen 232, wherein another side of the rotary drum 30 has an integral radially protruded second side board 34, so as to form a limited space for the rescue cord 40 to circle within between the first side board 33 and the second side board 34, wherein a free end of the rescue cord 40 can pass through a lower hole of the shell body 10 to connect to a buffering structure 41 on which bottom side was set a hook 42 to hookingly connect to a safety belt of the user;

a rotor 50 accommodated in the foramen 232, wherein the rotor 50 comprises a central opening 51 which passes through both the left and right sides of the rotor 50, four eccentric screw holes 52, and at least an eccentric through hole 53, wherein the eccentric screw holes 52 are for the third screws 253 to lockingly affix with, so as to lockingly affix both the rotor 50 and the first side board 33 on a side of the rotary drum 30, wherein the rotor 50 further has a solid trough 54 radially connecting inside and outside of the eccentric throughhole 53, and a blocking arm 55 protruded from a side of the trough solid 54;

at least a bias rotary member formed from an eccentric block 61 and a reset spring 62, wherein the eccentric block 61 has a pivot portion 611 couplingly positioned at the eccentric through hole 53, a curving handle 612 protruded from the trough solid 54, and a detent portion 613 set on a free end of the curving handle 612, wherein an outer end of the inside of the detent portion 613 has a second spring base 614 which allows the reset spring 62 to connect between the second spring base 614 and the first spring base 331, so as to provide the eccentric block 61 a potential to withdraw for positioning at any time, which allows the curving handle 612 to move away from the blocking arm 55 and let the inside of the detent portion 613 appressing on the peripheral of the rotor 50;

a turbination spring 70 accommodated in said chamber 24, wherein the outer end 71 of the turbination spring 70 is affixed on the supporting rack 20 and the inner end 72 of the turbination spring 70 is affixed on another side of the rotary drum 30, so as to provide said rotary drum 30 a predetermined acting force to give the rotary drum 30 the potential to roll said rescue cord 40 back at any time; and

a central axle 80 passing through the first hole 211, the turbination spring 70, the central hole 31 of the rotary drum 30, the central opening 51 of the rotor 50, and the crossing chamber 24 of the second hole 237, so that when the user is walking aerially or falling, the rotary drum 30 and the rotor 50 are allowed to roll by the central axle 80 in dealing with the instant stretching of the rescue cord 40 and to put a centrifugal force on the bias rotary member to let the eccentric block 61 overpower the reset spring 62 to leaningly move outward with the pivots of the pivot portion 611 and the eccentric through hole 53, so as to let the curving handle 612 to lean against the blocking arm 55 and to have the detent portion 613 to buckle in the positioning unit 234, so that the rotary drum 30 and the rotor 50 are fixated by the breaking frame 23 of the supporting rack 20 and unable to turn, which achieves the effect of safety and anti-dropping.

Therefore, the supporting rack 20 of the present invention is able to separate the breaking frame 23 in advance, so as to let the central axle 80 to pass through the turbination spring 70, the central hole 31 of the rotary drum 30, the central opening 51 of the rotor 50, and the second hole 237 of the breaking frame 23 in a manner of maximum moving allowance after the central axle 80 has passingly caught the first hole 211 of the upright board 21. Then the breaking frame 23 is set on the lateral board 22. Similarly, the supporting rack 23 of the present invention can also, as the breaking frame 23 was taken off in advance, let the central axle 80 pass through the central opening 51 of the rotor 50, the central hole 31 of the rotary drum 30, the turbination spring 70, and the first hole 211 of the upright board 21 in a manner of maximum moving allowance after the central axle 80 has passingly caught the second hole 237 of the breaking frame 23. Then, the breaking frame 23 is set on the lateral board 22.

According to the above description, it is known that the present invention at least has the following advantages:

First, in the present invention the assembling of the central axle 80 does not have to be restricted by the supporting rack 20, and the rotor 50 and the rotary drum 30 also do not have to be limited in a reverse U shaped chamber as the previous mentioned published application described, so the sight for assembly of the present invention is good to let the central axle 80 to directly easily pass through the central opening 51 of the rotor 50 and the central hole 31 of the rotary drum 30. Therefore the present invention can effectively lower the disadvantage of the frequent alignments and adjustments of the previous mentioned published application, so as to allow an evolutionarily great creation and provide economic efficiency.

Second, the present invention can control the turning tightness of the central axle 80 through the locking tension of the first screw 251 only, which structural setting is certainly unprecedented.

Third, the present invention allows a three fold increase in the chance for the detent portion 613 to buckle in the positioning unit 234 than that of the previous mentioned published application by setting three symmetrical positioning units 234 of the foramen and two bias rotary members, so the present invention has a non-obviousness element of high sensitivity.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An anti-dropping device, which comprises:
a supporting rack, which is formed from an upright board having a first hole, a lateral board extended from a top side of said upright board, and a breaking frame detachably installed on a free end of said lateral board, to define a chamber, wherein said breaking frame has a foramen concentric with said first hole, a covering board sealing off an outer side of said foramen, wherein said covering board has a second hole matching said first hole;
a rotary drum accommodated in said chamber, circled by a rescue cord, and piercingly set a central hole in said rotary drum;
a rotor accommodated in said chamber, affixedly placed on a side of said rotary drum, piercingly set a central opening in said rotor, and having a bias rotary member which withdraws for positioning at any time;
a turbination spring accommodated in said chamber and serialized in the middle of said rotary drum and said supporting rack to provide said rotary drum a potential to roll said rescue cord back at any time; and
a central axle passing through said first hole, said turbination spring, said central hole of said rotary drum, said central opening of said rotor, said crossing chamber of said second hole for allowing said rotary drum and said rotor to roll by said central axle to deal with the instant stretching of said rescue cord and to put a centrifugal force on said bias rotary member, so as to let said bias rotary member to be fixated by said foramen of said breaking frame.

2. The anti-dropping device as recited in claim 1, wherein a first binding hole and a first screw hole are correspondingly set where said lateral board and said breaking frame attach to one another, so as to allow a first screw to affix said lateral board with said breaking frame, so as to detachably install said breaking frame on said free end of said lateral board.

3. The anti-dropping device as recited in claim 1, wherein said foramen pierces said breaking frame, wherein a second binding hole and a second screw hole are correspondingly set where said covering board and said breaking frame attach to one another, so as to allow a second screw to affix said covering board with said breaking frame, so as to detachably seal said covering board on said foramen.

4. The anti-dropping device as recited in claim 1, wherein a center of said lateral board has a coupling hole for installation of a hanging set.

5. The anti-dropping device as recited in claim 4, wherein said hanging set is formed from a turning holder and a lifting lug, wherein said turning holder has a base portion stopped on a bottom side of said lateral board and has an axle portion which is extended up from said bottom side of said lateral board and passes through said coupling hole, wherein said axle portion concavedly has a radially penetrated cutting slot which is to be inserted by said base portion of said lifting lug, wherein said axle portion and said lifting lug have a corresponding first pivot hole and a corresponding second pivot hole to let an axle element to couple said first pivot hole with said second pivot hole, wherein the top portion of said lifting lug has a fixing hole to hangingly secure.

6. The anti-dropping device as recited in claim 5, wherein a washer for said axle portion of said turning holder to pass through is installed between said base portion of said turning holder and said bottom side of said lateral board.

7. The anti-dropping device as recited in claim 4, wherein said supporting rack is peripherally covered by a shell body which is formed by coupling a first shell and a second shell, wherein a top side of said shell body has an upper hole for said hanging set to reach out and a bottom side of said shell body has a lower hole for the free end of said rescue cord to protrude out.

8. The anti-dropping device as recited in claim 1, wherein said rotary drum has a central hole which passes through both a left side and a right side of said rotary drum, and a plurality of eccentric holes which are for a third screw to passingly catch to lockingly affix a first side board which has a radial protrusion on a side of said rotary drum, wherein another side of said rotary drum has an integral radial protrud on a second side board, so as to form a limited space for said rescue cord to circle with inbetween said first side board and said second side board, wherein said rotor has a central opening which passes through both a left side and a right side of said rotor, and a plurality of eccentric screw holes that are for said third screw to lockingly affix with, so as to lockingly affix both said rotor and said first side board on a side of said rotary drum.

9. The anti-dropping device as recited in claim 1, wherein said breaking frame has at least one positioning unit radially hollowed at said foramen, wherein said rotary drum has a first spring base set on a side thereof, wherein said first side board further symmetrically has at least one first spring base inserting in said foramen, wherein said rotor further has a trough solid radially connecting inside and outside of an eccentric through hole, and a blocking arm protruded from a side of said trough solid, wherein said bias rotary member is formed from an eccentric block and a reset spring, wherein said eccentric block has a pivot portion couplingly positioning at said eccentric through hole, a curving handle protruded from said trough solid, and a detent portion set on a free end of said curving handle, wherein an outer end of the inside of said detent portion has a second spring base which allows said reset spring to connect between said second spring base and said first spring base, so as to provide said eccentric block a potential to withdraw for positioning at any time, which allows said curving handle to move away from said blocking arm and let the inside of said detent portion to appress on a peripheral portion of said rotor, wherein as said rescue cord is instantly stretched, said eccentric block can overpower said reset spring to leaningly move outward with the pivots of said pivot portion and said eccentric through hole, so as to let said curving handle to lean against said blocking arm and to have said detent portion to buckle in said positioning unit, so that said rotary drum and said rotor are fixated by said breaking frame of said supporting rack for preventing said rotary drum and said rotor from turning.

10. The anti-dropping device as recited in claim 2, wherein said foramen pierces said breaking frame, wherein a second binding hole and a second screw hole are correspondingly set where said covering board and said breaking frame attach to one another, so as to allow a second screw to affix said covering board with said breaking frame, so as to detachably seal said covering board on said foramen.

11. The anti-dropping device as recited in claim 2, wherein a center of said lateral board has a coupling hole for installation of a hanging set.

12. The anti-dropping device as recited in claim 11, wherein said hanging set is formed from a turning holder and a lifting lug, wherein said turning holder has a base portion stopped on a bottom side of said lateral board and has an axle portion which is extended up from said bottom side of said lateral board and passes through said coupling hole, wherein said axle portion concavedly has a radially penetrated cutting slot which is to be inserted by said base portion of said lifting lug, wherein said axle portion and said lifting lug have a corresponding first pivot hole and a corresponding second pivot hole to let an axle element to couple said first pivot hole with said second pivot hole, wherein the top portion of said lifting lug has a fixing hole to hangingly secure.

13. The anti-dropping device as recited in claim 12, wherein a washer for said axle portion of said turning holder to pass through is installed between said base portion of said turning holder and said bottom side of said lateral board.

14. The anti-dropping device as recited in claim 11, wherein said supporting rack is peripherally covered by a shell body which is formed by coupling a first shell and a second shell, wherein a top side of said shell body has an upper hole for said hanging set to reach out and a bottom side of said shell body has a lower hole for the free end of said rescue cord to protrude out.

15. The anti-dropping device as recited in claim 2, wherein said rotary drum has a central hole which passes through both a left side and a right side of said rotary drum, and a plurality of eccentric holes which are for a third screw to passingly catch to lockingly affix a first side board which has a radial protrusion on a side of said rotary drum, wherein another side of said rotary drum has an integral radial protrud on a second side board, so as to form a limited space for said rescue cord to circle with inbetween said first side board and said second side board, wherein said rotor has a central opening which passes through both a left side and a right side of said rotor, and a plurality of eccentric screw holes that are for said third screw to lockingly affix with, so as to lockingly affix both said rotor and said first side board on a side of said rotary drum.

16. The anti-dropping device as recited in claim 2, wherein said breaking frame has at least one positioning unit radially hollowed at said foramen, wherein said rotary drum has a first spring base set on a side thereof, wherein said first side board further symmetrically has at least one first spring base inserting in said foramen, wherein said rotor further has a trough solid radially connecting inside and outside of an eccentric through hole, and a blocking arm protruded from a side of said trough solid, wherein said bias rotary member is formed from an eccentric block and a reset spring, wherein said eccentric block has a pivot portion couplingly positioning at said eccentric through hole, a curving handle protruded from said trough solid, and a detent portion set on a free end of said curving handle, wherein an outer end of the inside of said detent portion has a second spring base which allows said reset spring to connect between said second spring base and said first spring base, so as to provide said eccentric block a potential to withdraw for positioning at any time, which allows said curving handle to move away from said blocking arm and let the inside of said detent portion to appress on a peripheral portion of said rotor, wherein as said rescue cord is instantly stretched, said eccentric block can overpower said reset spring to leaningly move outward with the pivots of said pivot portion and said eccentric through hole, so as to let said curving handle to lean against said blocking arm and to have said detent portion to buckle in said positioning unit, so that said rotary drum and said rotor are fixated by said breaking frame of said supporting rack for preventing said rotary drum and said rotor from turning.

17. An anti-dropping device, comprising a supporting rack, wherein said supporting rack is formed from an upright board having a first hole, a lateral board extended from a top side of said upright board, and a breaking frame detachably installed on a free end of said lateral board, to define a chamber, wherein said breaking frame has a foramen concentric with said first hole and a covering board sealing off an outer side of said foramen, wherein said covering board has a second hole matching said first hole, so as to allow said first hole and said second hole to be passed through by a central axle.
